(19) United States
(12) Patent Application Publication
(10) Pub. No.: US 2009/0322960 A1
(43) Pub. Date: Dec. 31, 2009

(54) Television Broadcasting Receiver

(75) Inventor: Tadao Takashima, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/409,199

(22) Filed: Mar. 23, 2009

(30) Foreign Application Priority Data
Jun. 30, 2008 (JP) 2008-171604

(51) Int. Cl. H04N 5/44

(52) U.S. Cl. 348/725

(57) ABSTRACT

According to the embodiment of the invention, a television broadcasting receiver includes: an input terminal to which a television broadcasting signal is inputted, the second standard being different from the first standard; a printed circuit board having the input terminal substantially at the center of the printed circuit board and having first and second tuner units, the first tuner unit being disposed on one side of the input terminal, the second tuner unit being disposed on another side of the input terminal; and a casing housing the printed circuit board and the first and second tuner units so that the input terminal is exposed to the outside, wherein each of the first and second tuner units performs frequency conversion on the television broadcasting signal according to the first standard or the second standard inputted to the input terminal to obtain a video signal or an audio signal corresponding one of the first standard and the second standard.

### CROSS-REFERENCE TO RELATED APPLICATIONS

This application is based upon and claims the benefit of priority from Japanese Patent Application No. 2008-171604, filed Jun. 30, 2008, the entire contents of which are incorporated herein by reference.

### BACKGROUND

1. Field

The present invention relates to a television broadcasting receiver capable of receiving at least one of digital television broadcasting and analog television broadcasting.

2. Description of the Related Art

In recent, television broadcasting has been digitalized. For example, in Japan, terrestrial digital television broadcasting was started in addition to BS (broadcasting satellite) broadcasting using a broadcasting satellite or CS (communication satellite) broadcasting using a communication satellite.

In a digital television broadcasting receiver for receiving digital television broadcasting, an RF (radio frequency) signal received by an antenna is converted into an intermediate frequency signal, and a TS signal (transport stream) is obtained from the intermediate frequency signal.

According to multiplication of broadcasting, that is, increase in broadcasting waves of television broadcasting, a demand for simultaneously receiving multi channels of television broadcasting is rising. For this reason, various broadcasting receivers provided with two tuners have been proposed.

In Japanese Utility Model Registration No. 3,083,281, there is disclosed an electronic tuner in which two tuner units are isolated from each other by an inner side plate and are housed in a single case.

In the electronic tuner disclosed in Japanese Utility Model Registration No. 3,083,281, since high frequency circuits of two tuner units are disposed close to each other, the inner side plate, that is, a high frequency shield plate is necessary. In addition, since the high frequency shield plate is used, two sets of sharable elements and connection terminals are necessary in each unit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic view illustrating a tuner mounted on a television broadcasting receiver according to an embodiment of the invention.

FIG. 2 is an exemplary schematic view illustrating an example of a shield case (outer case) of the tuner shown in FIG. 1.

FIG. 3 is an exemplary schematic view illustrating another example of the shield case (outer case) shown in FIG. 2.

FIG. 4 is an exemplary schematic view illustrating another example of the shield case (outer case) shown in FIG. 2.

### DETAILED DESCRIPTION

Various embodiments according to the invention will be described hereinafter with reference to the accompanying drawings. In general, according to one embodiment of the invention, a television broadcasting receiver includes: an input terminal to which at least one of a television broadcasting signal according to a first standard and a television broadcasting signal according to a second standard is inputted, the second standard being different from the first standard; a printed circuit board having the input terminal substantially at the center of the printed circuit board in a longitudinal direction and having first and second tuner units, the first tuner unit being disposed on one side of the input terminal in the longitudinal direction, the second tuner unit being disposed on another side of the input terminal in the longitudinal direction; and a casing housing the printed circuit board and the first and second tuner units so that the input terminal is exposed to the outside, wherein each of the first and second tuner units performs frequency conversion on the television broadcasting signal according to the first standard or the second standard inputted to the input terminal to obtain a video signal or an audio signal corresponding one of the first standard and the second standard.

Hereinafter, an example of an embodiment of the invention will be described with reference to the drawings.

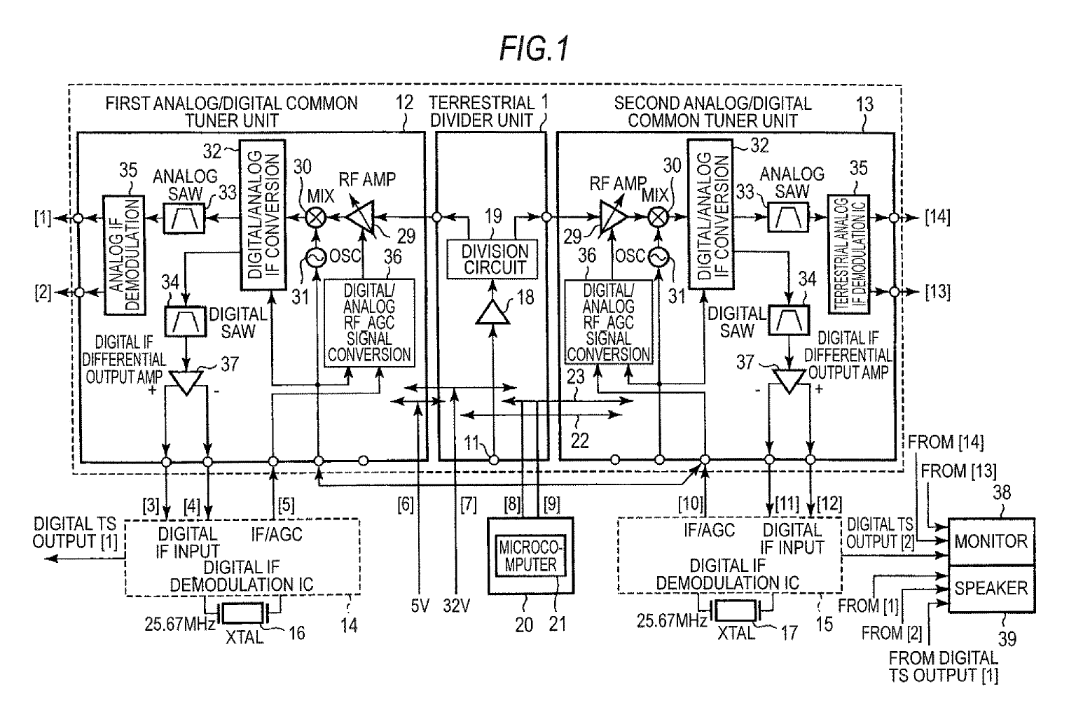

FIG. 1 is a schematic view illustrating a tuner mounted on, for example, a television broadcasting receiver for receiving digital television broadcasting and analog television broadcasting provided through a space wave, an optical fiber, or the like, or a set top box mainly used for cable television broadcasting or the like and serving as an external tuner.

The television broadcasting receiver (set top box) or an integrated double reception tuner shown in FIG. 1 includes: for example, an input terminal 11 for inputting a television broadcasting wave or an input signal supplied from the outside through a coaxial cable (non-equilibrium cable), that is, an RF (radio frequency) signal; a divider 1 for dividing the input RF signal to the input terminal 11 and supplying the divided signals to first and second tuner units 12 and 13; and the first and second tuner units 12 and 13 connected to the divider 1 and demodulating the television broadcasting wave for any broadcasting channel or the input signal. The first and second tuner units 12 and 13 have substantially the same configuration. The first and second tuner units 12 and 13 are connected to first and second digital demodulators 14 and 15 (digital intermediate frequency signal demodulation circuit) having substantially the same configuration, respectively. The digital demodulators 14 and 15 include crystal oscillators 16 and 17 used for local oscillators, respectively.

The divider 1 includes a high frequency (first-stage) amplifier 18 for amplifying the RF signal input to the input terminal 11 up to a predetermined level, and a division circuit 19 for dividing the RF signal amplified by the high frequency amplifier 18 to the first and second tuner units.

Each of the first and second tuner units 12 and 13 includes a variable gain amplifier 29 for amplifying the RF signal input from the division circuit 19 up to a predetermined level, and a mixing unit 30 for mixing the RF signal amplified by the variable gain amplifier 29 with a local oscillation signal (local oscillation frequency) generated in the local oscillator 31 to output an intermediate frequency signal (intermediate frequency).

The intermediate frequency signal output from the mixing unit 30 is supplied to a digital/analog IF (intermediate frequency) conversion circuit 32. At the time of receiving analog television broadcasting, the conversion circuit 32 leads the analog intermediate frequency signal supplied from the mixing unit 30, to an analog SAW (surface acoustic wave) filter 33. At the time of receiving digital intermediate frequency broadcasting, the conversion circuit 32 leads the digital intermediate signal supplied from the mixing unit 30, to a digital SAW filter 34. The analog television signal and the digital television signal are input to the different filters, respectively. The digital/analog IF conversion signal of the digital/analog IF conversion circuit 32 is supplied to a digital/analog AGC signal RF (radio frequency) conversion circuit 36, by the control of a microcomputer 21 of the control unit 20 connected to control buses 22 and 23 commonly provided for the first and second tuner unit 12 and 13. Power of 5 V (volt) and 32 V (volt) used to operate individual elements are commonly used in the first and second tuner units 12 and 13.

The analog intermediate frequency (IF) signal filtered by the analog SAW filter 33 is demodulated by an analog demodulation unit (analog intermediate frequency (IF) modulator) 35, and the modulated signal is provided to generate an analog video component and an analog audio component. That is, the analog intermediate frequency signal input to the analog demodulation unit 35 is supplied an analog audio processing unit and an analog audio processing unit connected to the rear ends thereof, as the analog video component and the analog audio component. The analog video processing unit and the analog audio processing unit connected to the ends are connected to a monitor 38 for reproducing video, or a speaker 39 for reproducing sound (audio) or an audio amplifier (not shown) connectable to a speaker, thereby outputting video and audio. Of course, a television receiver provided integrally with a monitor (display) and a speaker may be connected to the analog video processing unit and the analog audio processing unit.

The digital intermediate frequency signal filtered by the digital SAW filter 34 is supplied to a differential output amplifier (digital intermediate frequency demodulator) 37, and is converted into differential outputs for enabling a demodulation process of a corresponding demodulator of the first and second digital demodulators 14 and 15 provided at the ends thereof.

The “+” and “−” outputs from the differential output amplifier 37 are input to a digital demodulator (digital intermediate frequency signal demodulation circuit) and are demodulated on the basis of a operation clock output from a crystal oscillator 16 (or 17), and the demodulated signals are output to the rear end as TS (transport stream) signals.

All of the digital/analog IF conversion circuit 32, the digital/analog AGC signal conversion circuit 36, and the local oscillator 31 are switched at the time of receiving analog television broadcasting and at the time of receiving digital television broadcasting, on the basis of the control signals of the microcomputer 21 of the control unit 20.

As shown in FIG. 1, the first and second tuner unit 12 and 13 are disposed between the divider 1 in a state of developing on both sides thereof. Accordingly, it is possible to improve isolation performance of a high frequency component between the first tuner unit 12 and the second tuner unit 13. Therefore, it is possible to remove a high frequency shield plate provided between the first tuner unit 12 and the second tuner unit 13. Since it is possible to reduce the size of the high frequency shield plate by using the high frequency shield plate even when isolation of the high frequency component is enhanced, it is possible to achieve simplification. Since a coaxial cable for connecting a divider or the like is not necessary, it is possible to reduce cost. Sine a reception frequency band range is wide from VHF to UHF in the case of receiving terrestrial digital television/analog television broadcasting, harmonics of a local oscillation frequency oscillated by the local oscillator of one tuner easily interfere with a reception band of the other tuner. Accordingly, the arrangement of the divider according to the invention is effective.

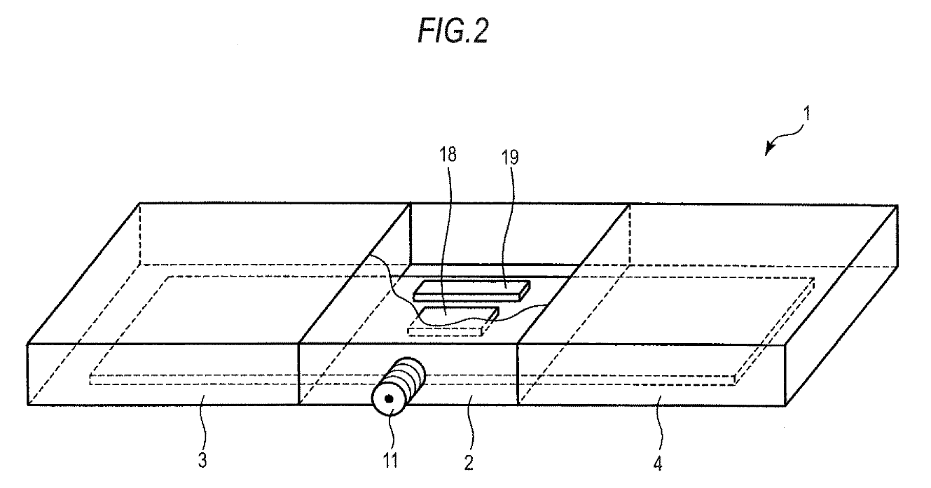

FIG. 2 is a schematic view illustrating appearance of the television broadcasting receiver shown in FIG. 1 and an example of arrangement of a pin (output terminal) group used for video output/sound(audio) output. The same reference numerals are given to the same elements (configuration) as the elements (configuration) described with reference to FIG. 1, and the detailed description thereof is omitted.

As shown in FIG. 2, the integrated double reception tuner, that is, the tuner (set top box) 1 having an input terminal 11 for inputting an RF (radio frequency) signal includes a shield case (divider shield case) 2 having a high frequency amplifier 18 and a division circuit 19 therein, and a first tuner unit shield case 3 and a second tuner unit shield case 4 provided on both sides of the shield case 2. The input terminal 11 for inputting an input signal or television broadcasting wave from the outside of the high frequency amplifier 18 is provided at a predetermined position of the shield case 2, and an RF signal supplied through a coaxial cable (not shown) is supplied to the high frequency amplifier 18.

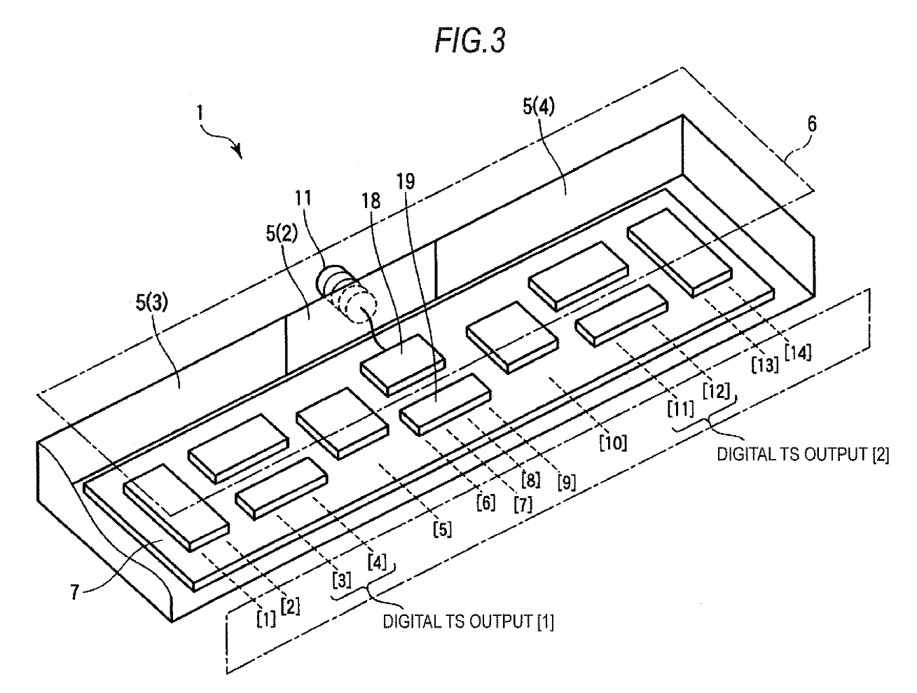

The first tuner unit shield case 3 and the second tuner unit shield case 4 are provided to be integrated with the divider shield case 2, or to share a part thereof with the divider shield case 2, and form substantially a single shield case. A shield plate for shielding a high frequency component between the first and second tuner units 12 and 13 or for attenuating an effect of the high frequency component may be provided at a border portion between the shield cases, as necessary. When the shield case 2, the first tuner unit shield case 3, and the second tuner unit shield case 4 are integrated, a common housing 5 (2, 3, 4) and a cover (cover member) 6 for covering the housing 5 may be separately provided as described with reference to FIG. 3.

FIG. 3 shows the shield case shown in FIG. 2, the first tuner unit shield case, and the second tuner unit shield case, that is, a state where the cover for covering the housing is removed from the housing.

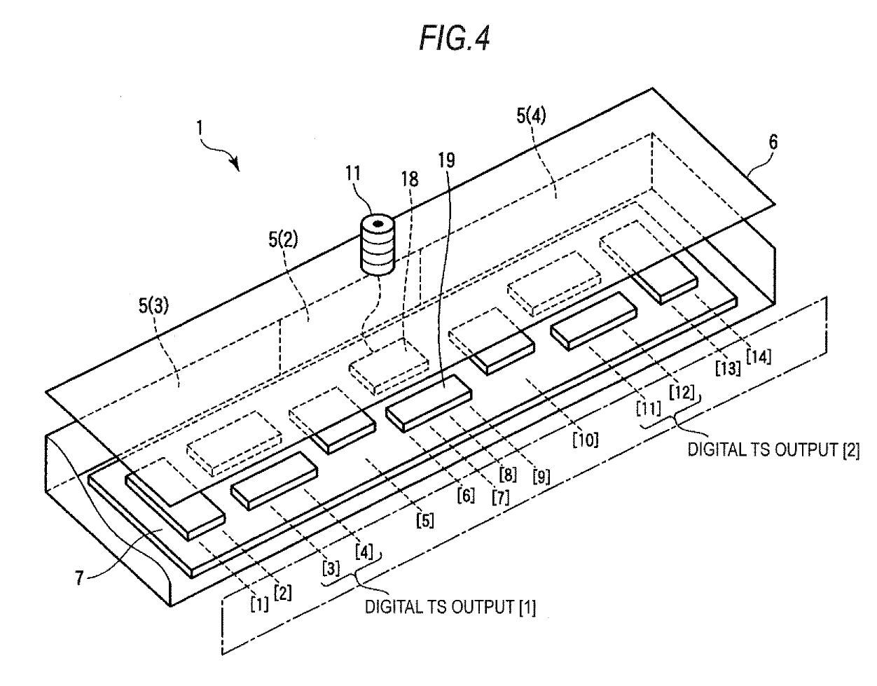

As shown in FIG. 3, a printed circuit board 7, on which the first and second tuner units 12 and 13 are integrally disposed, is housed in the housing 5. The divider 1 is disposed substantially at the center of a longitudinal direction of the printed circuit board 7. Accordingly, the input terminal 11 for inputting an input signal or television broadcasting wave supplied through, for example, a coaxial cable is fixed at a predetermined position of the housing 5. As shown in FIG. 4, the input terminal 11 may be provided on the cover 6 side.

Output terminals of the first and second tuner unit 12 and 13, power supply lines, and a control input terminal for inputting control signals from the control unit 20 are provided on one side of the housing 5 and on the side (in the example shown in FIG. 4, one side of the housing 5 most away from the side, on which the input terminal 11 is provided, in a width direction perpendicular to the longitudinal direction of the printed circuit board 7) opposite to the side on which the input terminal 11 is provided.

The output terminals of the first and second tuner units 12 and 13 may be described with reference to pin numbers [n(n is a natural number)] from the left side shown in FIG. 3 as follows, for example, a first tuner audio (sound) output [1], a first tuner video output [2], a first tuner digital IF (interface) output (sound/video common differential output (+)) [3], a first tuner digital IF (interface) output (sound/video common differential output (−)) [4], a first tuner digital AGC input [5], a 5 V power supply line [6] of the printed circuit board 7, a 32 V power supply line [7] of the printed circuit board 7, a data output (SDA) [8] from the microcomputer 21 to the control bus of the printed circuit board 7, a clock output (SCL) [9] to the control bus of the printed circuit board 7, a second tuner digital AGC input [10], a second tuner IF (interface) output (sound/video common differential output (−)) [11], a second tuner digital IF (interface) output (sound/video common differential output (+)) [12], a second tuner video output [13], and a second audio (sound) output [14] are arranged (are allocated) in order. The first tuner digital IF outputs [3] and [4] and the second tuner digital IF outputs [11] and [12] correspond to the digital TS output [1] and the digital TS output [2], respectively, as shown in FIG. 1.

As can be seen from the arrangement of the pins shown in FIG. 3, the signal lines and the power supply lines that can use the common wiring patterns are integrated on the printed circuit board 7. Accordingly, it is possible to reduce the number of pins inserted to the printed circuit board 7 and needing to be fixed by soldering, and it is possible to reduce the size of the tuner. It is possible to reduce the time (the number of processes) for assembling by reducing the number of pins. In addition, it is possible to simplify the wiring patterns formed on the printed circuit board 7. Therefore, it is possible to prevent unnecessary radiation from occurring.

As shown in FIG. 4, it is natural that the positional relation of the input terminal 11 and the shield case can be freely set. FIG. 4 shows another example of arrangement of the input terminal in the tuner shown in FIG. 3. The connection between the inner configurations (elements) of the shield case and the output terminals (pins) is substantially the same, and thus the detailed description thereof is omitted.

As described above, it is possible to improve isolation performance of a high frequency component between the first tuner unit and the second tuner unit. Therefore, it is possible to remove a high frequency shield plate necessarily provided between the first tuner unit and the second tuner unit. Since it is possible to reduce the size or thickness of the high frequency shield plate by using the high frequency shield plate even when isolation of the high frequency component is enhanced, it is possible to achieve simplification. Since a coaxial cable for connecting a divider or the like is not necessary, it is possible to reduce cost. Sine a reception frequency band range is wide from VHF to UHF in the case of receiving terrestrial digital television/analog television broadcasting, harmonics of a local oscillation frequency oscillated by the local oscillator of one tuner easily interfere with a reception band of the other tuner. Accordingly, the arrangement of the divider according to the invention is effective.

The signal lines and the power supply lines that can use the common wiring patterns are integrated on the printed circuit board. Accordingly, it is possible to reduce the number of pins inserted to the printed circuit board and needing to be fixed by soldering, and it is possible to reduce the size of the tuner. It is possible to reduce the time (the number of processes) for assembling by reducing the number of pins. In addition, it is possible to simplify the wiring patterns formed on the printed circuit board. Therefore, it is possible to prevent unnecessary radiation from occurring.

The invention is not limited to the embodiment described herein, and may be variously modified within the scope of the invention. The embodiment may be appropriately combined or a part thereof may be omitted. In that case, it is possible to obtain various effects caused by the combination or omission.

An object of the invention is to provide a television broadcasting receiver capable of cutting the high frequency shield plate between the first tuner and the second tuner, and reducing the size and the number of assembly processes for assembling.

According to the invention, it is possible to improve isolation performance of a high frequency component between the first tuner unit and the second tuner unit. Therefore, it is possible to remove a high frequency shield plate necessarily provided between the first tuner unit and the second tuner unit. Since it is possible to reduce the size or thickness of the high frequency shield plate by using the high frequency shield plate even when isolation of the high frequency component is enhanced, it is possible to achieve simplification. Since a coaxial cable for connecting a divider or the like is not necessary, it is possible to reduce cost. Sine a reception frequency band range is wide from VHF to UHF in the case of receiving terrestrial digital television/analog television broadcasting, harmonics of a local oscillation frequency oscillated by the local oscillator of one tuner easily interfere with a reception band of the other tuner. Accordingly, the arrangement of the divider according to the invention is effective.

What is claimed is:

1. A television broadcasting receiver comprising:
an input terminal to which at least one of a television broadcasting signal according to a first standard and a television broadcasting signal according to a second standard is inputted, the second standard being different from the first standard;
a printed circuit board having the input terminal substantially at the center of the printed circuit board in a longitudinal direction and having first and second tuner units, the first tuner unit being disposed on one side of the input terminal in the longitudinal direction, the second tuner unit being disposed on another side of the input terminal in the longitudinal direction; and
a casing housing the printed circuit board and the first and second tuner units so that the input terminal is exposed to the outside,
wherein each of the first and second tuner units performs frequency conversion on the television broadcasting signal according to the first standard or the second standard inputted to the input terminal to obtain a video signal or an audio signal corresponding one of the first standard and the second standard.

2. The television broadcasting receiver according to claim 1,
wherein the printed circuit board further includes a control bus to be shared by the first and second tuner units, and
wherein the printed circuit board further includes a power supply line to be shared by the first and second tuner units.

3. The television broadcasting receiver according to claim 2 further comprising:
a control signal input terminal connected to the control bus, and
a power input terminal connected to the power supply line.

4. The television broadcasting receiver according to claim 1, wherein the input terminal is configured to be connected to an input medium so that the input medium is parallel to the face of the printed circuit board.

5. The television broadcasting receiver according to claim 1, wherein the input terminal is configured to be connected to an input medium so that the input medium is orthogonal to the face of the printed circuit board.

6. The television broadcasting receiver according to claim 1 further comprising:
a monitor configured to reproduce the video signal according to the first standard or the video signal according to the second standard; and
a speaker configured to reproduce the audio signal according to the first standard or the audio signal according to the second standard.
